(19) United States
(12) Patent Application Publication
(10) Pub. No.: US 2002/0117767 A1
(43) Pub. Date: Aug. 29, 2002

(54) Encapsulated phosphor with reduced surface area

(76) Inventors: Richard G. W. Gingerich, Towanda, PA (US); Clarence D. Vanderpool, Towanda, PA (US)

Correspondence Address: OSRAM SYLVANIA Inc., 100 Endicott Street, Danvers, MA, 01923, US

(21) Appl. No.: 10/010,981

(22) Filed: Dec. 7, 2001

Related U.S. Application Data
(60) Provisional application No. 60/256,284, filed on Dec. 18, 2000.

(51) Int. Cl. B29C 39/10

(52) U.S. Cl. 264/4

(57) ABSTRACT

A method of reducing the surface area of an encapsulated phosphor includes the steps of preparing a homogeneous mixture of an encapsulated phosphor and a surface area reducing agent selected from the group consisting essentially of boric acid and ammonium dihydrogen phosphate and firing the mixture for a time and at a temperature to reduce the surface area of the encapsulated phosphor.

This application is priority from Provisional Patent Application Ser. No. 60/256,284, filed Dec. 18, 2000.

### TECHNICAL FIELD

This application relates to electroluminescent phosphors and more particularly to such phosphors having moisture resistant coatings thereon. Still more particularly, it relates to such phosphors having a coating of reduced surface area and increased efficacy and life.

### BACKGROUND ART

Phosphors are a known class of materials that emit electromagnetic radiation, usually in the visible region of the spectrum, upon excitation by another form of energy. Phosphors are usually named for the type of energy to which they susceptible. For example, cathodoluminescent phosphors are excited to emission by impingement of electrons or cathode rays; photoluminescent phosphors are excited to emission by impingement of actinic radiation; x-ray phosphors by the impingement of x-rays; and electroluminescent phosphors by the action of an electric field, usually supplied by an alternating current. It is with the latter type of phosphor that this invention is most particular concerned.

Commercial electroluminescent phosphors are mostly based upon a host material of zinc sulfide activated by one or more activators among which are copper and/or manganese and/or chloride, which are incorporated into the host structure. These phosphors have uses as lamps or illuminating sources for readout devices or watch faces. Two basic kinds are employed, one in which the phosphor is dispersed id in an organic binder and laminated in plastic, and a second variety in which the phosphor is dispersed in a ceramic dielectric and fused to a metal plate.

The plastic variety is the more economical; however, the light output of the phosphor encased in an economical plastic such as Mylar™ degrades rapidly, such phosphors having a half-life of about 50 hours at operation at 400 Hz and 100 volts. (The half-life of a phosphor is that point in time its when its light output is reduced by half from some initial light output). Incorporation of the phosphor in a more expensive plastic lamina such as Aclar™ will produce a lamp having much better life (for example, a half-life of 500 to 2000 hours at operating levels of 400 Hz and 100 volts) with however, a concomitant increase in the cost of the lamp.

To further increase the life of the electroluminescent phosphors it is known to encapsulate individual phosphor particles with a continuous, conformal, dielectric, moisture-inhibiting material that allows the use of the phosphor in the less expensive plastic materials.

For example, U.S. Pat No. 6,064,150 teaches an electroluminescent phosphor having thereon a coating of aluminum nitride or aluminum nitride amime. Other coatings have included mettallic oxides or compounds such as aluminum oxide hydroxide. An instance of the latter is disclosed in Ser. No. 09/153,978, filed Sep. 16, 1998 and assigned to the assignee of this invention.

Occasionally, even phosphors provided with an encapsulation are found to have short half-lives and low efficacies. This unwanted condition has been attributed to the encapsulation coating being too porous, thus allowing moisture to penetrate.

It would be an advance in the art if the half-lives and efficacies of these materials could be improved.

### DISCLOSURE OF INVENTION

It is, therefore, an object of this invention to obviate the disadvantages of the prior art.

It is another object of the invention to enhance electroluminescent phosphors.

It is yet another object of the invention to improve the half-life and efficacy of electroluminescent phosphors.

These object are accomplished, in one aspect of the invention, by a method of reducing the surface area of an encapsulated phosphor by the steps comprising: preparing a homogeneous mixture of an encapsulated phosphor and a surface area reducing agent selected from the grow consisting essentially of boric acid and ammonium dihydrogen phosphate and firing the mixture for a time and at a temperature to reduce the surface area of the encapsulated phosphor.

Reducing the surface area of the coated phosphors provides significant increases in both the half-life and efficacy of the encapsulated phosphors.

### BEST MODE FOR CARRYING OUT THE INVENTION

For a better understanding of the present invention, together with other and further objects advantages and capabilities thereof, reference is made to the following disclosure and appended claims.

Results are shown in Tables I and II.

TABLE I

| | | | | Lamp Performance | | | |
|---|---|---|---|---|---|---|---|
| | | | | Light Output | | | |
| | | BET | Aluminum | 24 Hrs. | 100 Hrs. | Life | Efficacy |
| Lot Number | Description of Treatment | m²/gm | % | ft. L | ft. L. | Hrs. | Lm/watt |
| 129C | Control, TMA + O₂ at 160° C. | 18.6 | 1.6 | 20.1 | — | 60 | 3.55 |
| 129A | 129 annealed air at 175° C. | 5.63 | 1.6 | 28 | — | 30 | 4.24 |
| CV81-731 | 129C + H₂O at rt | 13.6 | 1.5 | 24.1 | — | 42 | 3.48 |
| CV81-70-1 | 129C + H₂O at 50 psi (microwave) | 9.15 | 1.6 | 23.2 | — | 38 | 3.49 |
| CV34581-80-1 | 129C + 1.0 X¹ H₃BO₃ at 177° C. in air | 0.40 | 1.6 | 21 | 12.8 | 105 | 6.00 |
| CV81-81-722 | 129C + 2.0 X¹ H₃BO₃ at 177° C. in air | 0.06 | 1.6 | 20.1 | — | 91 | 5.62 |
| CV81-723 | 129C + 8.0 X¹ H₃BO₃ at 177° C. in air | 0.07 | 1.4 | 16.6 | 10.8 | 121 | 5.69 |
| CV34581-87-1 | 129C + 0.6 X¹ NH4H₂PO₄ at 177° C. in air | 1.42 | 1.4 | 14.1 | 7.8 | 91 | 6.17 |
| CV34620-6-1 | 129C + 1.2 X¹ NH₄H₂PO₄ at 177° C. in air | | | 21.6 | — | 39 | 4.98 |

TABLE II

Lamp Performance
Light Output

| | | BET | Aluminum | 24 Hrs. | 100 Hrs. | Life | Efficacy |
|---|---|---|---|---|---|---|---|
| Lot Number | Description of Treatment | m²/gm | % | ft. L | ft. L. | Hrs. | lm/watt |
| 190A | Control, TMA + O₂ at 160° C. | 17.4 | 1.5 | 20.9 | — | 35.6 | 3.79 |
| 34620-17-1 | 190A × 2X¹ H₃BO₃ at 175° C. in air | 0.17 | 1.1 | 21.6 | — | 75.0 | 5.2 |
| 34620-17-2 | 190A × 2X¹ H₃BO₃ at 175° C. N₂ | 0.26 | 1.1 | 21.6 | — | 71.0 | 5.3 |

A portion of a first batch of ZnS:Cu,Cl electroluminescent phosphor (designated Lot 129C) was encapsulated with an aluminum compound in a fluid nitrogen bed via the reaction of trimethylalumimum and oxygen as is known. Reaction temperature was 160° C. The resultant material had a surface area of 18.6 m²/gm (BET) and, when tested in lamps, the time to half-life was 60 hours and the efficacy was 3.55 lm/watt. This material is shown as the control in Table I.

Other portions of the first batch were annealed in air at 175° C.; in water at room temperature and in water 50 psi (in a microwave). The results are of these tests are shown in Table I as Lot Numbers 129A, CV81-731 and CV81-70-1, respectively.

The best results according to an aspect of the invention were obtained (Lot Number CV34581-80-1, Table I) by treating other portions of the first batch by firing in air with boric acid (i.e., H₃BO₃) at 177° C. Specifically, prior to firing, 43.8 grams of the 129C control encapsulate electroluminescent phosphor were mixed with 1.5 grams of boric acid in a 250 cc polyethylene bottle. The mixture was shaken on a paint shaker for 10 minutes and any agglomerations were spatulated to make a homogeneous mixture. This homogeneous mixture was then fired for 16 hours at 177° C. As clearly seen in Table I, this procedure reduced the surface area from 18.6 m²/gm to 0.40 m²/gm and increased the half-life to 105 hours and the efficacy to 6.00 lumens per watt. In Tables I and II the designation 1.0 X⁻¹, etc., indicates the molar ratio of the indicated compounds versus 1 mole of aluminum. As will be apparent from Table I, excellent results were obtained even as the amount of boric acid increased to a molar ratio of 8 (CV81-723).

Similarly, firing yet other portions of the control in air at 177° C. with a 0.6 molar ratio of ammonium dihydrogen phosphate to 1 mole of aluminum provided greatly improved results, the material having a half-life of 91 hours and an efficacy of 6.1 lumens per watt. Doubling the amount of ammonium dihydrogen phosphate still provided increased efficacy, however, with a decided loss of time to half-life to 39 hours.

Table II shows the results of a second trial with a second batch of encapsulated material. The control in this instance is designated 190A. This material had a slightly lower amount of aluminum (1.5% versus 1.6% for the 129C) and a slightly lower surface area.

Portions of this material were treated with boric acid after mixing as before and fired at a lower temperature, 175° C. versus 177° C., one batch being fired in air and another being fired in nitrogens. Both firings provided better results than the control; however, the results were not quite as good as Lot Number CV81-81-722 from Table I, which employed the same amount of boric acid.

While there have been shown and described what are at present considered to be the preferred embodiments of the invention, it will be apparent to those skilled in the art that various changes and modification can be made herein without departing from the scope of the invention as defined by the appended claims.

What is claimed is:

1. In a method of reducing the surface area of an encapsulated phosphor the steps comprising: preparing a homogeneous mixture of an encapsulated phosphor and a surface area reducing agent seed from the group consisting essentially of boric acid and ammonium dihydrogen phosphate and firing said mixture for a time and at a temperature to reduce said surface area of said encapsulated phosphor.

2. The method of claim 1 wherein sad encapsulated phosphor is encapsulated with an aluminum-containing compound.

3. The method of claim 2 wherein said firing time is about 16 hours.

4. The method of claim 3 wherein said temperature is about 175 to 177° C.
